(19) United States
(12) Patent Application Publication
(10) Pub. No.: US 2025/0356222 A1
(43) Pub. Date: Nov. 20, 2025

(54) SYSTEM AND METHOD FOR OPTIMAL AND TRANSPARENT AI-ASSISTED DECISION-MAKING IN INTELLECTUAL PROPERTY INNOVATION AND STRATEGY

(71) Applicants: Alan W McCord, Forney, TX (US); Liam A McCord, Forney, TX (US)

(72) Inventors: Alan W McCord, Forney, TX (US); Liam A McCord, Forney, TX (US)

(21) Appl. No.: 18/668,244

(22) Filed: May 20, 2024

Related U.S. Application Data
(60) Provisional application No. 63/503,476, filed on May 20, 2023.

(51) Int. Cl. G06N 5/022

(52) U.S. Cl. CPC G06N 5/022

(57) ABSTRACT

The present invention is an AI-driven system for automating and accelerating optimal, transparent creative decision-making and problem-solving in intellectual property innovation and strategy. It comprises a multi-media user interface and four software agents: problem-definition (PD-Agent), model-construction (UBMC-Agent), solution-control (SOLVE-Agent), and explanatory (EXPLAIN-Agent). These agents dynamically construct a domain-specific language and ontology, convert it into a computable model, solve the model using automated solution methods, and explain the results to stakeholders. The multi-agent architecture separates problem definition, model construction, solution, and explanation phases while leveraging generative AI language and foundation models in a controlled manner. This enables large-scale quantitative decision-making with objective alignment, transparency, and interactivity, suitable for intellectual property innovation and strategy applications.

### CROSS-REFERENCE TO RELATED APPLICATIONS

This application claims the benefit of, and priority to, 62/125,747, titled, “SYSTEM AND METHOD FOR OPTIMAL AND TRANSPARENT AI-ASSISTED DECISION-MAKING IN INTELLECTUAL PROPERTY INNOVATION AND STRATEGY”, and filed on May 20, 2023, the entire specification of which is incorporated herein by reference.

### BACKGROUND OF THE INVENTION

### Field of the Art

The present invention relates to the field of artificial intelligence and decision-making, specifically in the domain of intellectual property innovation and strategy. The invention aims to provide a system and method for automating and accelerating optimal and transparent decision-making using AI while ensuring alignment with human stakeholders' objectives.

### Discussion of the State of the Art

Existing approaches to AI-assisted decision-making suffer from several limitations. Traditional methods often lack a straightforward domain-specific language (DSL) that enables non-technical stakeholders to set up and use a computerized decision-making system. They also have a limited ability to perform “outer loops” of model change and feedback and to trade off compute time, costs, degree of approximation, and risk/robustness.

Approaches based solely on generative large language models (LLMs) have limitations in holding large, precise data graphs for decision-making, controlling bias, and providing transparency and explanation of decisions. They also struggle with aligning the objectives of pre-trained LLMs with the specific objectives of the problem at hand.

The current invention addresses these limitations by providing a multi-agent system that separates the problem definition, model construction, solution, and explanation phases, while leveraging the strengths of LLMs and foundation models in a controlled manner.

### SUMMARY OF THE INVENTION

The present invention is a system and method for automating and accelerating optimal and transparent creative decision-making and problem-solving using Artificial Intelligence in a way that seals and encapsulates the decision definitions, entities, relationships, causes, events, constraints, and designs involved in the decision so that they are fully observable and protected from spurious or fabricated elements inserted by pre-trained generative AI language and foundation models. This allows for large-scale quantitative decision-making with objective alignment.

The system comprises a multi-media user interface for decision stakeholders to communicate with the system, a problem-definition software agent (PD-Agent) that coordinates the dynamic construction of a domain-specific language and ontology, a model-construction software agent (UBMC-Agent) that converts the ontology into a sealed, computable model, a solution-control software agent (SOLVE-Agent) that solves the sealed model using automated selection of solution methods, and an explanatory software agent (EXPLAIN-Agent) that explains the decision results back to the human stakeholders.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a flow diagram illustrating interactions between the software agents and human stakeholders through a multi-media user interface of the AI-assisted decision-making system.

FIG. 6 is a block diagram illustrating an AI-assisted decision-making system.

FIG. 7 is a flow diagram illustrating a method for a PD-Agent.

FIG. 8 is a flow diagram illustrating a method for a UBMC-Agent.

FIG. 9 is a flow diagram illustrating a method for a SOLVE-Agent.

FIG. 10 is a flow diagram illustrating a method for a EXPLAIN-Agent.

### DETAILED DESCRIPTION

The inventor has conceived, and reduced to practice, a system and method for automating and accelerating optimal and transparent creative decision-making and problem-solving using Artificial Intelligence (AI) in the domain of intellectual property innovation and strategy. The system aims to address the limitations of existing approaches by providing a multi-agent architecture that separates the problem definition, model construction, solution, and explanation phases while leveraging the strengths of generative AI language and foundation models in a controlled manner.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions.

Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

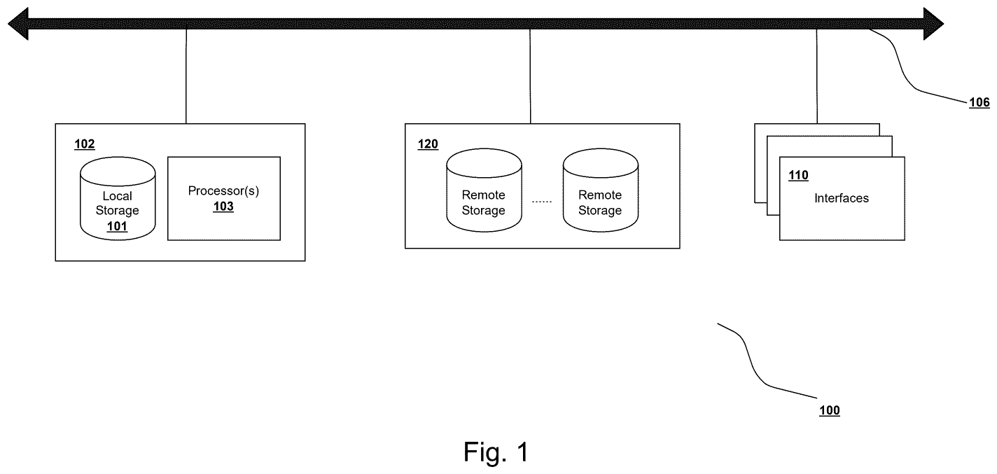

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

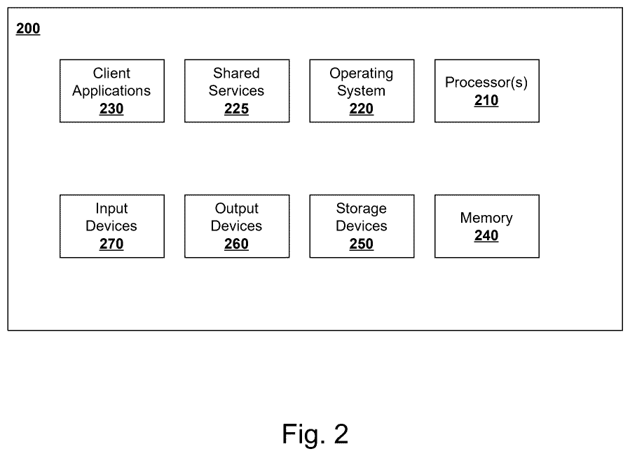

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

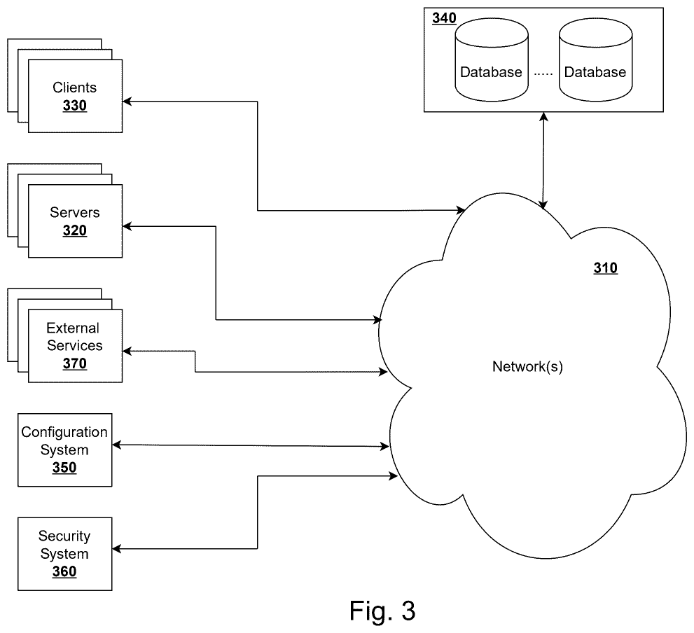

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

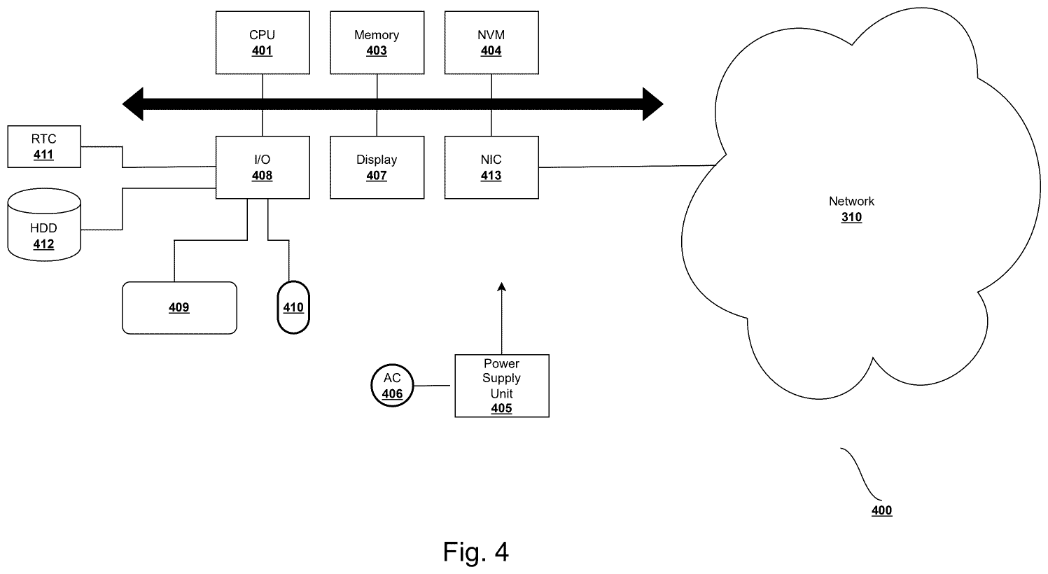

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

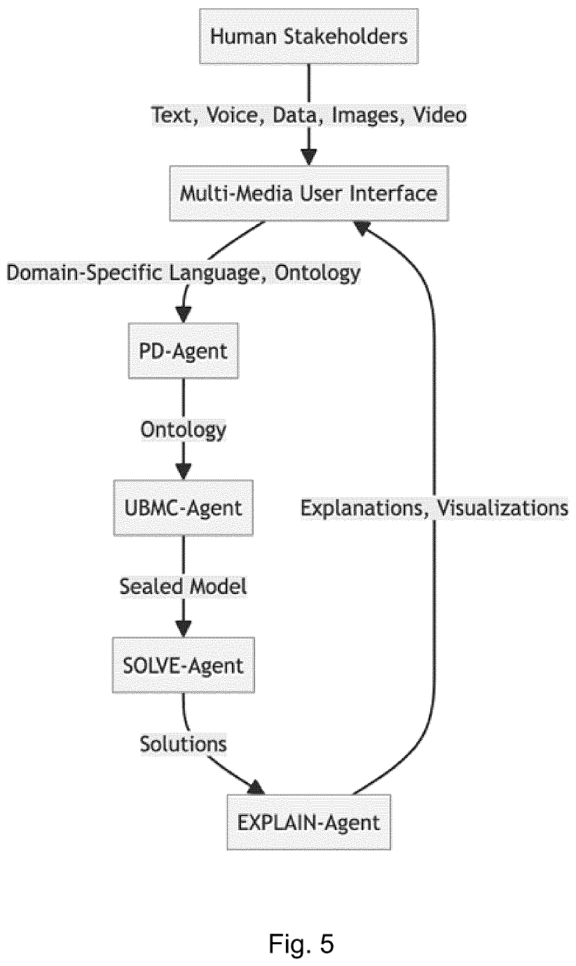

FIG. 5 is a flow diagram illustrating interactions between the software agents and human stakeholders through a multi-media user interface of the AI-assisted decision-making system.

The AI-assisted decision-making system comprises four main software agents: the Problem-Definition Agent (PD-Agent), the Universal Boundary Model Construction Agent (UBMC-Agent), the Solution Agent (SOLVE-Agent), and the Explanation Agent (EXPLAIN-Agent). These agents work together to facilitate optimal and transparent decision-making while ensuring alignment with human stakeholders' objectives.

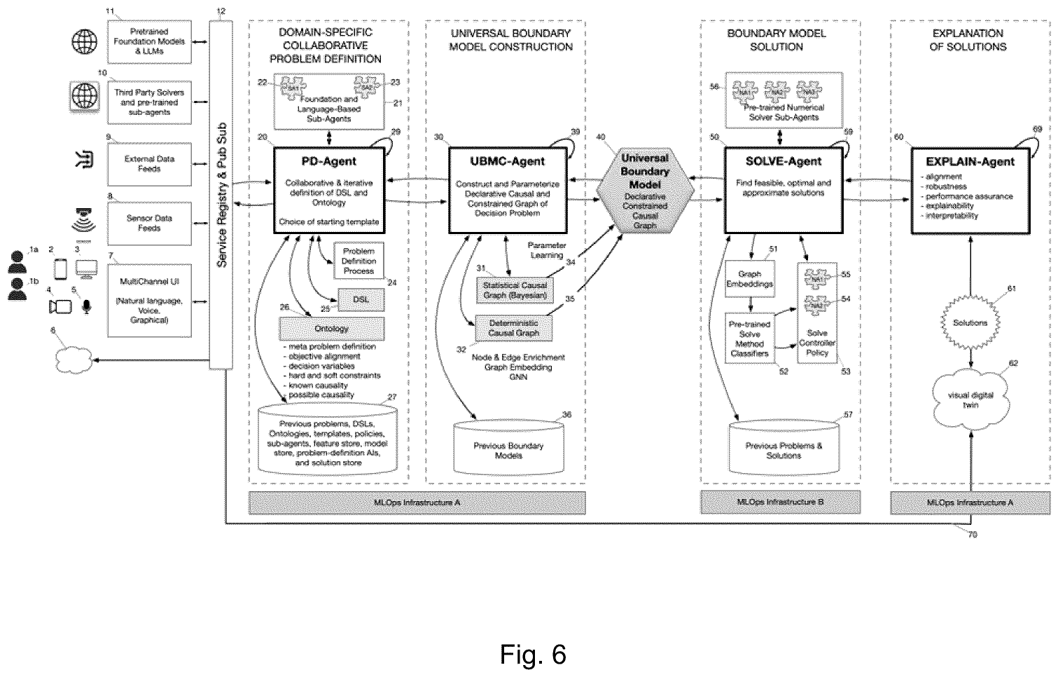

FIG. 6 is a block diagram illustrating an AI-assisted decision-making system providing a detailed view of the system architecture. One or more human users, either a decision maker (1a) or decision stakeholder (1b) connect through the multichannel user interfaces (7) of the system which are running on one or more of a smartphone (2), tablet device or computer (3) all of which can support bidirectional video & image (4) and voice (5) interaction. Additional interfaces for interaction via Virtual Reality or Augmented Reality (6) are also supported.

There is a Service Registry and Publish and Subscribe system (12) for dynamically updating the system with the presence and availability of the end users (1), the sensors (8), external data feeds (9), third party solvers and pre-trained agents (10) (if any) and third-party or local Pretrained Foundation and Language Models (11).

Once the users are authenticated and connected, they begin to interact with the Problem-Definition Agent (PD-Agent). The following sections describe the subsequent functioning of the system, agent by agent.

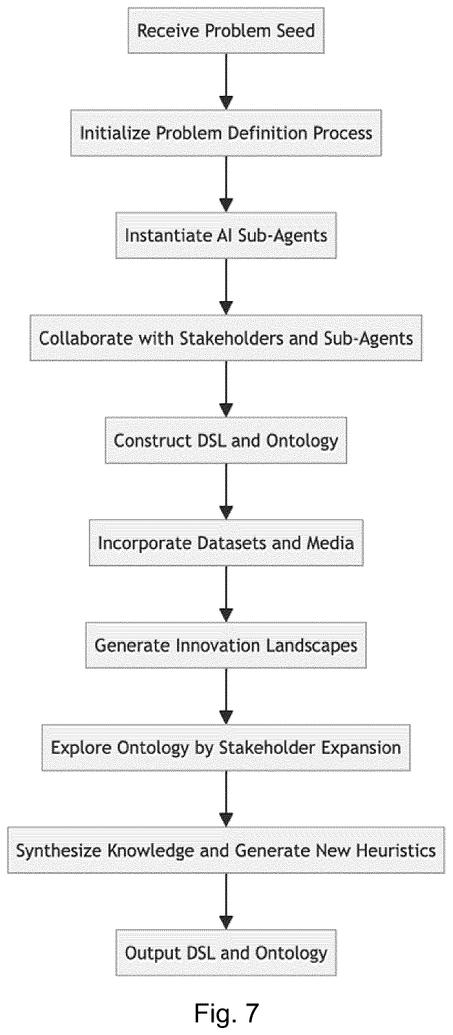

FIG. 7 is a flow diagram illustrating a method for a PD-Agent. The PD-Agent is responsible for coordinating the dynamic construction of a domain-specific language (DSL) and ontology for the decisions to be made. It serves as the interface between human decision stakeholders and the AI system, facilitating communication and collaboration.

The PD-Agent receives a problem seed from the stakeholders and initializes the problem definition process. It instantiates AI sub-agents, including generative language model sub-agents and foundation model sub-agents, to assist in the process. The PD-Agent collaborates with stakeholders and sub-agents to construct the DSL and ontology, incorporating datasets and media as needed.

The PD-Agent also generates innovation landscapes to help stakeholders visualize and explore the problem space. It expands the ontology by identifying additional stakeholders and their perspectives. The agent synthesizes knowledge from various sources and generates new problem-solving heuristics. Finally, it outputs the completed DSL and ontology to the UBMC-Agent.

The ontology is converted into a declarative graph using techniques such as graph neural networks and embedding methods. In the case of a Mixed Integer Linear Programming (MILP) problem, the declarative graph is represented as a bipartite graph, with decision variables and constraints as nodes and their relationships as edges. Deep learning methods, such as graph convolutional networks and attention mechanisms, can be employed to learn meaningful representations of the graph structure and node features.

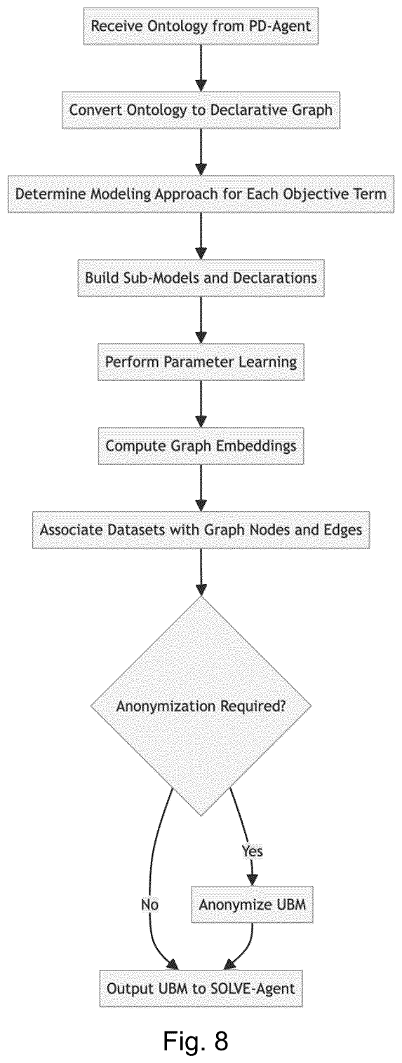

FIG. 8 is a flow diagram illustrating a method for a UBMC-Agent. The UBMC-Agent is responsible for converting the ontology received from the PD-Agent into a sealed, computable model called the Universal Boundary Model (UBM). The UBM encapsulates the decision definitions, entities, relationships, causes, events, constraints, and designs involved in the decision, ensuring they are fully observable and protected from spurious or fabricated elements.

The UBMC-Agent receives the ontology from the PD-Agent and converts it into a declarative graph. It determines the appropriate modeling approach for each term in the objective function, considering the granularity of modeling required and any additional causal structure. The agent builds sub-models and declarations, including decision variable definitions and constraints.

Parameter learning is performed using statistical causal graphical methods applied to datasets. Graph embeddings are computed at the node, edge, subgraph, and graph levels using graph neural networks, incorporating any attached foundation model embeddings. Datasets are made purely numerical and associated with nodes or edges in the UBM.

If anonymization is required, the UBMC-Agent applies a one-way hash to decision variable names, constraint names, and objective reward function expressions. Simulation subgraphs are mapped to general simulation agents, and domain-specific entity names are replaced with standard names and IDs.

The resulting UBM is a sealed, computable model that can represent various problem types, including MILP, simulation, and constraint programming problems. The UBM is outputted to the SOLVE-Agent for solution.

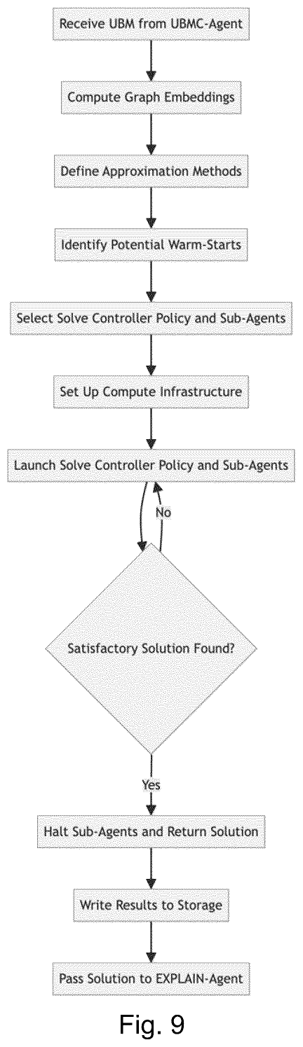

FIG. 9 is a flow diagram illustrating a method for a SOLVE-Agent. The SOLVE-Agent is responsible for finding feasible or optimal solutions to the Universal Boundary Model (UBM) received from the UBMC-Agent. It employs automated selection of solution methods, along with techniques for fast approximate solutions and decision-making under uncertainty when requested by the stakeholders.

The SOLVE-Agent receives the UBM from the UBMC-Agent and computes graph embeddings at various levels. It defines approximation methods based on the embeddings and identifies potential warm-start solutions from previous similar problems. Pre-trained solve method classifiers are used to select the best solve controller policy and numerical optimization sub-agents, along with their pre-tuned parameters.

The SOLVE-Agent sets up the necessary compute infrastructure, including remote infrastructure if required, and launches the selected solve controller policy and sub-agents. The solve controller policy monitors the solution progress and takes actions to optimize the solve objective. Once a satisfactory solution is found, the solve controller policy halts all sub-agents, and the solution is returned.

The solution results are written to storage for later training of the pre-trained solve method classifiers. The SOLVE-Agent passes the solution to the EXPLAIN-Agent and sends a progress event to all other top-level agents.

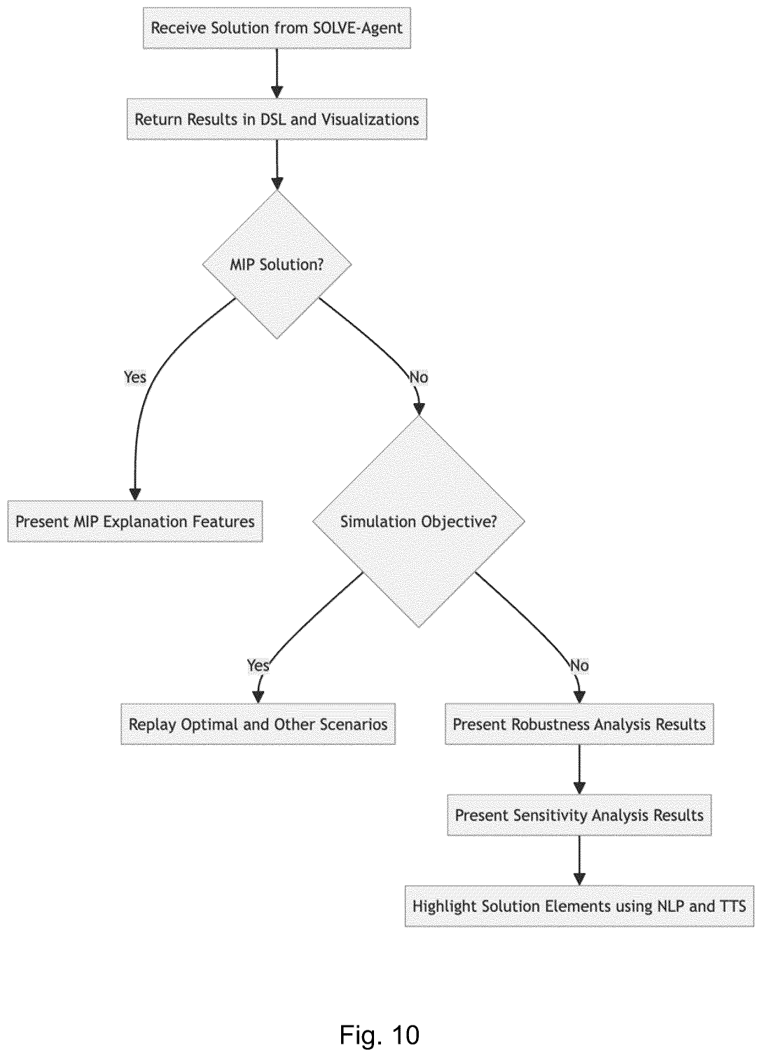

FIG. 10 is a flow diagram illustrating a method for an EXPLAIN-Agent. The EXPLAIN-Agent is responsible for generating explanations and visualizations of the solution(s) received from the SOLVE-Agent. It presents the results to the decision stakeholders in the domain-specific language and through interactive graphics and visualizations.

The EXPLAIN-Agent receives the solution(s) from the SOLVE-Agent and returns the results to the stakeholders in the domain-specific language, along with visualizations of decision variables, constraints, and key performance indicators. Depending on the problem type and stakeholder preferences, the agent presents additional explanations and analyses.

For MIP solutions, the EXPLAIN-Agent provides explanations of the contribution of decision variables and constraints to the objective function. In the case of simulation objectives, the agent replays the optimal scenario alongside other scenarios, allowing stakeholders to explore the dynamics and causal behavior visually.

Robustness and sensitivity analyses are presented to the stakeholders, highlighting the solution's performance under various uncertain scenarios and the impact of changes in problem parameters. The EXPLAIN-Agent uses natural language processing and text-to-speech to highlight specific parts of the solution and provide commentary.

The EXPLAIN-Agent leverages the open and transparent nature of the UBM to generate comprehensive and interpretable explanations, enabling stakeholders to understand and trust the AI-assisted decision-making process.

FIG. 5 provides an overview of the system architecture, illustrating the interactions between the software agents and the human stakeholders through a multi-media user interface

The skilled person will be aware of a range of possible modifications of the various embodiments described above. Accordingly, the present invention is defined by the claims and their equivalents.

What is claimed is:

1. A system for automating and accelerating optimal and transparent creative decision-making and problem-solving using Artificial Intelligence, comprising:
a. a multi-media user interface for decision stakeholders to communicate with the system by text, voice, data, images, and video;
b. a problem-definition software agent (PD-Agent) that coordinates the dynamic construction of a domain-specific language and ontology for the decisions to be made, which serves as the language used for communication between human decision stakeholders and machines;
c. a model-construction software agent (UBMC-Agent) that converts said ontology into a sealed, computable model of the decisions to be made;
d. a solution-control software agent (SOLVE-Agent) that solves the said sealed model using automated selection of solution methods with additional techniques to find fast approximate solutions and to handle decision making under uncertainty where requested by the decision stakeholders; and
e. an explanatory software agent (EXPLAIN-Agent) that explains the decision results back to the human stakeholders.

2. The system of claim 1, wherein the model-construction software agent (UBMC-Agent) includes a Turing-complete simulation specification within the said sealed model for elements of the decision problem which require simulation.

3. The system of claim 1, wherein the model-construction software agent (UBMC-Agent) creates an anonymized version of the said sealed model so solutions can be performed by third parties in a secure way.

4. The system of claim 1, wherein the problem-definition software agent (PD-Agent) includes a method that allows decision stakeholders to create a strategic landscape map of the relative semantic positions of selectable elements involved in the decision-making ontology, including the ability to automatically generate new innovative candidate elements and attributes by a stakeholder selecting an area of open space on the map.

5. The system of claim 1, further comprising an augmented reality/virtual reality system for decision stakeholders to interactively explore visualizations of the said sealed model, said problem-definition, and said solutions, including comparison of solutions and replay of any simulations.

6. A method for automating and accelerating optimal and transparent creative decision-making and problem-solving using Artificial Intelligence, comprising the steps of:
providing a multi-media user interface for decision stakeholders to communicate with the system by text, voice, data, images, and video;
coordinating the dynamic construction of a domain-specific language and ontology for the decisions to be made using a problem-definition software agent (PD-Agent), which serves as the language used for communication between human decision stakeholders and machines;
converting said ontology into a sealed, computable model of the decisions to be made using a model-construction software agent (UBMC-Agent);
solving the said sealed model using a solution-control software agent (SOLVE-Agent) with automated selection of solution methods and additional techniques to find fast approximate solutions and to handle decision making under uncertainty where requested by the decision stakeholders; and
explaining the decision results back to the human stakeholders using an explanatory software agent (EXPLAIN-Agent).

7. The method of claim 6, wherein the model-construction software agent (UBMC-Agent) includes a Turing-complete simulation specification within the said sealed model for elements of the decision problem which require simulation.

8. The method of claim 6, wherein the model-construction software agent (UBMC-Agent) creates an anonymized version of the said sealed model so solutions can be performed by third parties in a secure way.

9. The method of claim 6, wherein the problem-definition software agent (PD-Agent) includes a step that allows decision stakeholders to create a strategic landscape map of the relative semantic positions of selectable elements involved in the decision-making ontology, including the ability to automatically generate new innovative candidate elements and attributes by a stakeholder selecting an area of open space on the map.

10. The method of claim 6, further comprising the step of providing an augmented reality/virtual reality system for decision stakeholders to interactively explore visualizations of the said sealed model, said problem-definition, and said solutions, including comparison of solutions and replay of any simulations.
